(19) United States
(12) Patent Application Publication
(10) Pub. No.: US 2011/0191818 A1
(43) Pub. Date: Aug. 4, 2011

(54) METHOD, APPARATUS, AND SYSTEM FOR IMPLEMENTING HOT-LINING FUNCTION

(75) Inventors: Yafeng ZHANG, Shenzhen (CN); Lei MI, Shenzhen (CN)

(73) Assignee: HUAWEI TECHNOLOGIES CO., LTD., Shenzhen (CN)

(21) Appl. No.: 13/087,700

(22) Filed: Apr. 15, 2011

Related U.S. Application Data
(63) Continuation of application No. PCT/CN2009/072754, filed on Jul. 14, 2009.

(30) Foreign Application Priority Data
Oct. 17, 2008 (CN) 200810171515.2

(51) Int. Cl. G06F 17/00

(52) U.S. Cl. 726/1

(57) ABSTRACT

A method, an apparatus, and a system for implementing a hot-lining function are provided, which relate to the field of communications, so as to solve a problem in the prior art that a solution for implementing the hot-lining function is unable to be provided. The technical solution includes: acquiring a hot-lining function enabling message sent from a hot-lining application (HLA) network element, where the hot-lining function enabling message carries hot-lining rule information; enabling the hot-lining function according to the hot-lining rule information in the enabling message, and instructing a hot-lining device (HLD) to enable the hot-lining function according to the hot-lining rule information. The technical solution is applicable to a fixed network and a wireless network.

### CROSS-REFERENCE TO RELATED APPLICATIONS

This application is a continuation of International Application No. PCT/CN2009/072754, filed on Jul. 14, 2009, which claims priority to Chinese Patent Application No. 200810171515.2, filed on Oct. 17, 2008, both of which are hereby incorporated by reference in their entireties.

### FIELD OF THE INVENTION

The present invention relates to the field of communications, and particularly to a method, an apparatus, and a system for implementing a hot-lining function.

### BACKGROUND OF THE INVENTION

At present, when a user is not authorized to access a network or acquire a network service due to some reasons, a network operator can provide a hot-lining function for the user, and the hot-lining function is able to stop a normal packet data service application of the user, notify the user that the data packet service application is already blocked, instruct the user to solve the problem, and recover normal operations when the problem is solved, or terminate the service when the problem fails to be solved. The network operator can provide continuous service experience for the user using the hot-lining function to avoid affecting the service experience of the user because of the network side randomly blocking or terminating the packet data service without notifying the user.

During the implementation of the present invention, the inventors find that the prior art does not provide a specific technical solution for implementing the hot-lining function.

### SUMMARY OF THE INVENTION

The present invention is directed to a method, an apparatus, and a system for implementing a hot-lining function.

To achieve the objectives, the present invention provides the following technical solutions.

A method for implementing a hot-lining function includes: acquiring a hot-lining function enabling message sent from a hot-lining application (HLA) network element, where the hot-lining function enabling message carries hot-lining rule information; and enabling a hot-lining function according to the hot-lining rule information in the enabling message, and instructing a hot-lining device (HLD) to enable the hot-lining function according to the hot-lining rule information.

A method for implementing a hot-lining function includes: sending a hot-lining function enabling message to an authentication, authorization and accounting (AAA) network element, where the hot-lining function enabling message carries hot-lining rule information and instructs the AAA network element to enable the hot-lining function according to the hot-lining rule information; receiving a data flow of a user; and providing a hot-lining service to the user according to the hot-lining rule information.

An AAA network element includes a hot-lining function enabling message acquiring unit (901) and a hot-lining function enabling unit (902).

The hot-lining function enabling message acquiring unit (901) is configured to acquire a hot-lining function enabling message sent from an HLA network element, where the hot-lining function enabling message carries hot-lining rule information.

The hot-lining function enabling unit (902) is configured to enable the hot-lining function according to the hot-lining rule information, and instruct a HLD to enable the hot-lining function according to the hot-lining rule information.

An HLA network element includes a hot-lining function enabling message sending unit (1201) and a hot-lining service providing unit (1202).

The hot-lining function enabling message sending unit (1201) is configured to send a hot-lining function enabling message to an AAA network element, where the hot-lining function enabling message carries hot-lining rule information, and instruct the AAA network element to enable the hot-lining function according to the hot-lining rule information.

The hot-lining service providing unit (1202) is configured to receive a data flow from a user, and provide a hot-lining service for the user according to the hot-lining rule information.

A system for implementing a hot-lining function includes an HLA network element (1401), an AAA network element (1402), and an HLD (1403).

The HLA network element (1401) is configured to send a hot-lining function enabling message that carries hot-lining rule information to the AAA network element (1402), receive a data flow of a user from the HLD (1403), and provide a hot-lining service for the user according to the hot-lining rule information.

The AAA network element (1402) is configured to receive the hot-lining function enabling message sent from the HLA network element (1401), enable the hot-lining function according to the hot-lining rule information carried in the hot-lining function enabling message, and instruct the HLD (1403) to enable the hot-lining function according to the hot-lining rule information.

The HLD (1403) is configured to enable the hot-lining function according to the instruction of the AAA network element (1402).

The present invention provides a method, an apparatus, and a system for implementing the hot-lining function, where the AAA network element enables the hot-lining function according to the hot-lining rule information carried in the hot-lining function enabling message sent from the HLA network element, and instruct the HLD to enable the hot-lining function according to the hot-lining rule information, and therefore make clear the information that needs to be transmitted during the enabling of the hot-lining function as well as the task that needs to be accomplished by each network element device, achieving the objective of implementing the hot-lining function.

### BRIEF DESCRIPTION OF THE DRAWINGS

FIG. 1 is a flow chart of a method for implementing a hot-lining function according to an embodiment of the present invention;

FIG. 2 is a flow chart of a method for implementing a hot-lining function according to another embodiment of the present invention;

FIG. 3 is a flow chart of a method for implementing a hot-lining function according to another embodiment of the present invention;

FIG. 4 is a flow chart of a method for implementing a hot-lining function according to further another embodiment of the present invention;

FIG. 5 is a flow chart of a method for implementing a hot-lining function according to further another embodiment of the present invention;

FIG. 6 is a flow chart of a method for implementing a hot-lining function according to further another embodiment of the present invention;

FIG. 7 is a flow chart of a method for implementing a hot-lining function according to further another embodiment of the present invention;

FIG. 8 is a flow chart of a method for implementing a hot-lining function according to further another embodiment of the present invention;

FIG. 9 is a first schematic structural view of an AAA network element according to an embodiment of the present invention;

FIG. 10 is a schematic structural view of a hot-lining function enabling unit 902 in the AAA network element according to an embodiment of the present invention as shown in FIG. 9;

FIG. 11 is a second schematic structural view of an AAA network element according to an embodiment of the present invention;

FIG. 12 is a first schematic structural view of an HLA network element according to an embodiment of the present invention;

FIG. 13 is a second schematic structural view of an HLA network element according to an embodiment of the present invention;

FIG. 14 is a first schematic structural view of a system for implementing a hot-lining function according to an embodiment of the present invention;

FIG. 15 is a second schematic structural view of a system for implementing a hot-lining function according to an embodiment of the present invention;

FIG. 16 is a sequence chart of a method, an apparatus, and a system for implementing a hot-lining function according to Embodiment 1 of the present invention;

FIG. 17 is a sequence chart of a method, an apparatus, and a system for implementing a hot-lining function according to Embodiment 2 of the present invention; and

FIG. 18 is a sequence chart of a method, an apparatus, and a system for implementing a hot-lining function according to Embodiment 3 of the present invention.

### DETAILED DESCRIPTION OF THE EMBODIMENTS

A method, an apparatus, and a system for implementing a hot-lining function of the present invention are described in detail below with reference to the accompanying drawings.

FIG. 1 is a flow chart of a method for implementing a hot-lining function according to an embodiment of the present invention. The method includes the following steps:

Step 101: An Authentication, Authorization and Accounting (AAA) network element acquires a hot-lining function enabling message sent from an Hot-Lining Application (HLA) network element, where the hot-lining function enabling message carries hot-lining rule information.

Step 102: The AAA enables the hot-lining function according to the hot-lining rule information, and instructs an Hot-Lining Device (HLD) to enable the hot-lining function according to the hot-lining rule information. The hot-lining function may be a hot-lining rectification function.

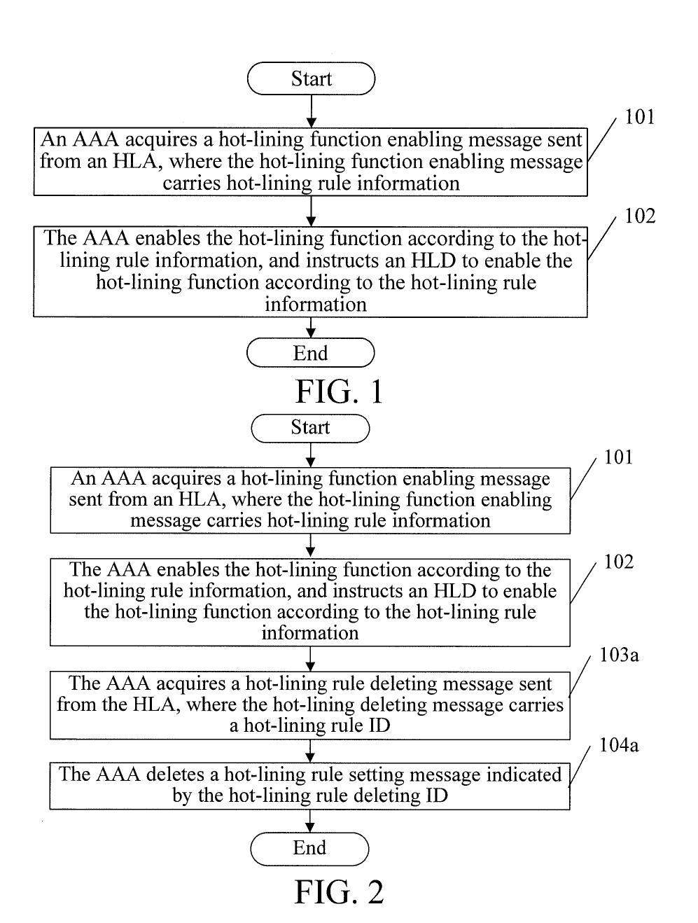

In another embodiment of the present invention, as shown in FIG. 2, the method for implementing the hot-lining function includes the following steps:

Step 101: An AAA acquires a hot-lining function enabling message sent from an HLA network element, where the hot-lining function enabling message carries hot-lining rule information.

In this embodiment, the hot-lining function enabling message may be hot-lining rule setting information. The hot-lining rule information carried in the hot-lining rule setting information may include a hot-lining rule identifier (ID), a hot-lining rule scope, a hot-line rule triggering condition, a user identity, a hot-lining rule type, a hot-lining rule, and a hot-lining session duration.

Step 102: The AAA enables the hot-lining function according to the hot-lining rule information, and instructs the HLD to enable the hot-lining function according to the hot-lining rule information.

The enabling the hot-lining function by the AAA according to the hot-lining rule information may specifically include the following steps:

The AAA determines whether a scope of the hot-lining rule setting message covers global users, partial users, or a single user according to the hot-lining rule scope carried in the hot-lining rule setting message. When it is determined that the scope of the hot-lining rule setting message covers global users, the AAA may not determine the user identity carried in the hot-lining rule setting message, and at this time, the user identity is empty. When it is determined that the scope of the hot-lining rule setting message covers partial users or a single user, the AAA determines the user identity carried in the hot-lining rule setting message, and acquires static user information of the hot-lining function to be enabled according to the user identity. In this embodiment, the user identity may be a Network Access Identifier (NAI) of the user, or a terminal identity of the user. The terminal identity of the user may be a Mobile Station ID (MSID) in a Worldwide Interoperability for Microwave Access (WiMAX) network, or an International Mobile Subscriber Identity (IMSI) in a Code Division Multiple Access (CDMA) network.

The AAA determines whether to immediately enable the hot-lining function for the global users indicated by the hot-lining rule scope, or partial users or a single user indicated by the hot-lining rule scope and the user identity according to the hot-lining rule triggering condition carried in the hot-lining function setting message. When the hot-lining rule triggering condition is unconditional enabling, the AAA immediately enables the hot-lining function upon receiving the hot-lining function setting message. When the hot-lining rule triggering condition is conditional enabling, the AAA may first acquire user information, and then determines whether the user information meets the hot-lining rule triggering condition. If the hot-lining rule triggering condition is met, the AAA enables the hot-lining function; and if the hot-lining rule triggering condition is not met, the AAA does not enable the hot-lining function.

The AAA determines the type of the hot-lining function to be enabled according to the hot-lining rule type carried in the hot-lining rule setting message. In this embodiment, the type of the hot-lining function may specifically include: a Hypertext Transfer Protocol-Redirection-Rule (HTTP-Redirection-Rule), an Internet Protocol (IP-Redirection-Rule), or a Network-Attached Storage-Filter-Rule (NAS-Filter-Rule), and the hot-lining rule type includes hot-lining function enabling type descriptions or a hot-lining rule type ID. The AAA may specifically determine the type of the hot-lining function to be enabled according to the specific hot-lining function enabling type description in the hot-lining rule type. For example, the AAA determines that the type of the hot-lining function to be enabled is IP-Redirection-Rule according to the IP-Redirection description in the hot-lining rule type, and may also determine the type of the hot-lining function to be enabled according to the hot-lining rule type ID in the hot-lining rule type. A one-to-one relationship is preset between a hot-lining rule type ID and a hot-lining function type. For example, it is preset that the hot-lining rule type ID being 1 corresponds to the IP-Redirection-Rule type, the hot-lining rule type ID being 2 corresponds to the HTTP-Redirection-Rule type, and the hot-lining rule type ID being 3 corresponds to the NAS-Filter-Rule type. Upon acquiring the hot-lining rule type being 1, the AAA determines that the hot-lining function type to be enabled is the IP-Redirection-Rule type. After determining the type of the hot-lining function to be enabled according to the hot-lining rule type, the AAA further determines the specific hot-lining function to be enabled among hot-lining functions included in the hot-lining function type according to the hot-lining rule carried in the hot-lining rule setting message and initiate the hot-lining function. In this embodiment, the hot-lining rule is specifically configured to describe the hot-lining function to be enabled in the hot-lining function type indicated by the hot-lining rule type. For example, when the hot-lining function type indicated by the hot-lining rule type is the HTTP-Redirection-Rule type, the hot-lining rule indicates an HTTP address to be redirected to.

The AAA may also perform the hot-lining function in a specified period according to the hot-lining session duration carried in the hot-lining rule setting message, and in this embodiment, the unit of the hot-lining session duration is second.

After the AAA and the HLD enable the hot-lining function, the method for implementing a hot-lining function according to the present invention may further include the following steps:

Step 103a: The AAA acquires a hot-lining rule deleting message sent from the HLA, where the hot-lining rule deleting message carries a hot-lining rule ID.

Step 104a: The AAA deletes the hot-lining rule setting message indicated by the hot-lining rule ID.

In this embodiment, the hot-lining rule setting message carries the hot-lining rule ID. When receiving more than two hot-lining rule setting messages, the AAA uniquely identifies one hot-lining rule setting message according to the hot-lining rule ID. When receiving the hot-lining rule deleting message, the AAA deletes the hot-lining rule setting message that carries the same hot-lining rule ID according to the hot-lining rule ID carried in the hot-lining rule deleting message.

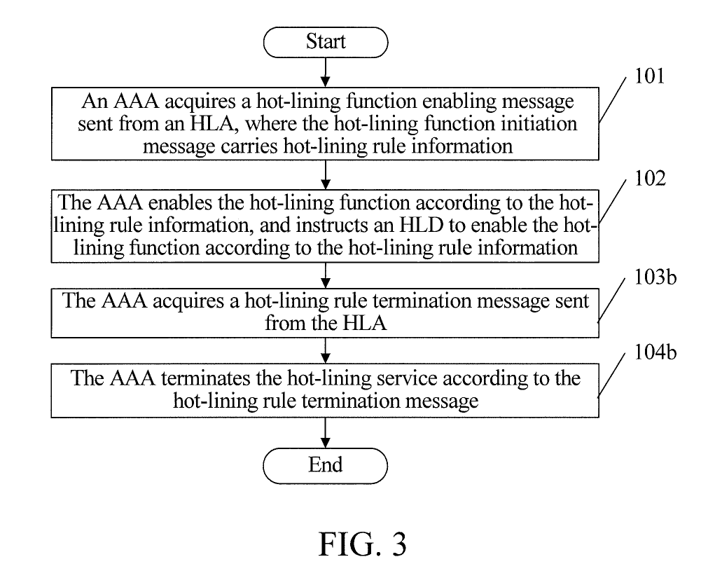

In another embodiment of the present invention, as shown in FIG. 3, the method for implementing a hot-lining function includes the following steps:

Step 101: An AAA acquires a hot-lining function enabling message sent from an HLA, in which the hot-lining function enabling message carries hot-lining rule information.

In this embodiment, the hot-lining function enabling message may be a hot-lining rule triggering message. The hot-lining rule information carried in the hot-lining rule triggering message may include a user identity (including an NAI of the user or a terminal identity of the user), a hot-lining rule type, a hot-lining rule, and hot-lining session duration.

Step 102: The AAA enables the hot-lining function according to the hot-lining rule information, and instructs an HLD to enable the hot-lining function according to the hot-lining rule information.

Step 102: After receiving the hot-lining rule triggering message, the AAA directly enables the hot-lining function for the user indicated by the user identity within the period specified by the hot-lining session duration according to the hot-lining rule type and the hot-lining function indicated by the hot-lining rule, which may specifically includes:

The AAA acquires the static user information of the hot-lining function to be enabled according to the user identity carried in the hot-lining rule triggering message, and determines the user for which the hot-lining function is to be enabled according to the static user information.

The AAA determines the type of the hot-lining function of the user to be enabled according to the type of the hot-lining rule carried in the hot-lining rule setting message. In this embodiment, the type of the hot-lining function may specifically include the HTTP-Redirection-Rule, the IP-Redirection-Rule, or the NAS-Filter-Rule. The type of the hot-lining rule may include the hot-lining function enabling type description or the hot-lining rule type ID. At this time, the AAA may specifically determine the type of the hot-lining function to be enabled according to the specific hot-lining function enabling type description in the hot-lining rule type. For example, the AAA determines that the type of the hot-lining function to be enabled is the IP-Redirection-Rule according to the IP-Redirection description in the hot-lining rule type. The AAA may also determine the type of the hot-lining function to be enabled according to the hot-lining rule type ID in the hot-lining rule type. A one-to-one relationship is preset between a hot-lining rule type ID and a hot-lining function type. For example, it is preset that the hot-lining rule type ID being 1 corresponds to the IP-Redirection-Rule type, the hot-lining rule type ID being 2 corresponds to the HTTP-Redirection-Rule type, and the hot-lining rule type ID being 3 corresponds to the NAS-Filter-Rule type. Upon acquiring the hot-lining rule type 1, the AAA determines that the type of the hot-lining function to be enabled is the IP-Redirection-Rule type. After determining the type of the hot-lining function to be enabled according to the hot-lining rule type, the AAA further determines the specific hot-lining function to be enabled among the hot-lining function included in the hot-lining function type according to the hot-lining rule carried in the hot-lining rule setting message and initiate the hot-lining function. In this embodiment, the hot-lining rule is specifically configured to describe the hot-lining function to be enabled in the hot-lining function type indicated by the hot-lining rule type. For example, when the type of the hot-lining function indicated by the hot-lining rule type is the HTTP-Redirection-Rule type, the hot-lining rule indicates the HTTP address to be redirected to.

The AAA may also perform the hot-lining function in a specified period according to the hot-lining session duration carried in the hot-lining rule setting message, and in this embodiment, the unit of the hot-lining session duration is second.

After the AAA and the HLD enable the hot-lining function, the method for implementing a hot-lining function according to the present invention may further include the following steps.

Step 103b: The AAA acquires a hot-lining rule termination message sent from the HLA.

In this embodiment, the hot-lining rule termination message may include a user identity (including an NAI of a user or a terminal identity of the user) and a hot-lining problem/condition termination result.

Step 104b: The AAA terminates the hot-lining service according to the hot-lining rule termination message, which may include the following steps:

The AAA determines whether the user has solved the problem that results in the enabling of the hot-lining function through the hot-lining service provided by the HLA according to the hot-lining problem/condition termination result carried in the hot-lining rule termination message. After determining that the user has solved the problem that results in the enabling of the hot-lining function, the AAA terminates the hot-lining service for the user indicated by the user identity according to the user identity carried in the hot-lining rule termination message; and if determining that the user does not solve the problem that results in the enabling of the hot-lining function, the AAA continues the hot-lining function, or terminates the service.

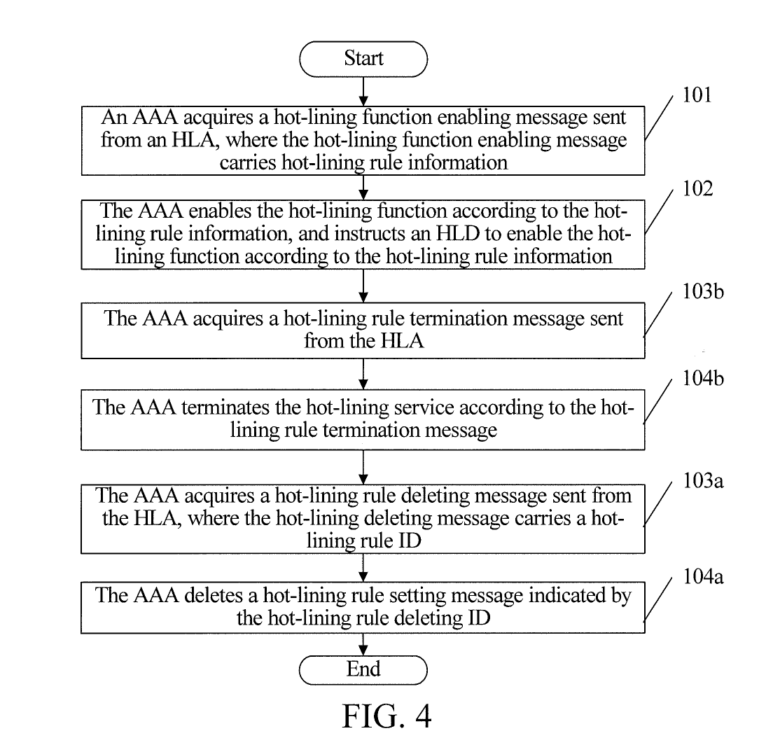

In further another embodiment of the present invention, as shown in FIG. 4, the method for implementing a hot-lining function includes the following steps:

Step 101: An AAA acquires a hot-lining function enabling message sent from an HLA, where the hot-lining function enabling message carries hot-lining rule information.

In this embodiment, the hot-lining function enabling message may be hot-lining rule setting information. The hot-lining rule information carried in the hot-lining rule setting information may include a hot-lining rule ID, a hot-lining rule scope, a hot-line rule triggering condition, a user identity, a hot-lining rule type, a hot-lining rule, and hot-lining session duration, where the hot-lining rule scope covers global users.

Step 102: The AAA enables the hot-lining function according to the hot-lining rule information carried in the hot-lining function enabling message, and instructs an HLD to enable the hot-lining function according to the hot-lining rule information. As for the specific implementing method thereof, reference is made to step 102 of FIG. 2, and the details are not described herein again.

After the AAA and the HLD enable the hot-lining function, when the AAA needs to terminate the hot-lining service for one or several users, the method for implementing the hot-lining function according to the present invention may further include the following steps:

Step 103b: The AAA acquires a hot-lining rule termination message sent from the HLA, where the hot-lining rule termination message may include a user identity (including an NAI of a user or a terminal identity of the user) and a hot-lining problem/condition termination result.

Step 104b: The AAA terminates the hot-lining service according to the hot-lining rule termination message; as for the specific method, reference is made to step 104b of FIG. 3, and the details are not described herein again.

Further, in this embodiment, after Step 104b, the method may further include the following steps:

Step 103a: The AAA acquires a hot-lining rule deleting message sent from the HLA, in which the hot-lining rule deleting message carries a hot-lining rule ID which is the same as the hot-lining rule ID carried in the hot-lining rule setting message.

Step 104a: The AAA deletes the hot-lining rule setting message indicated by the hot-lining rule ID.

The method for implementing the hot-lining function according to the embodiment implements the hot-lining function, enables the user to enjoy continuous experience when the user has some problems to access the network or acquire the network service, and terminates the hot-lining function in time when the problems of the user are solved, so as to guarantee normal service operation of the user.

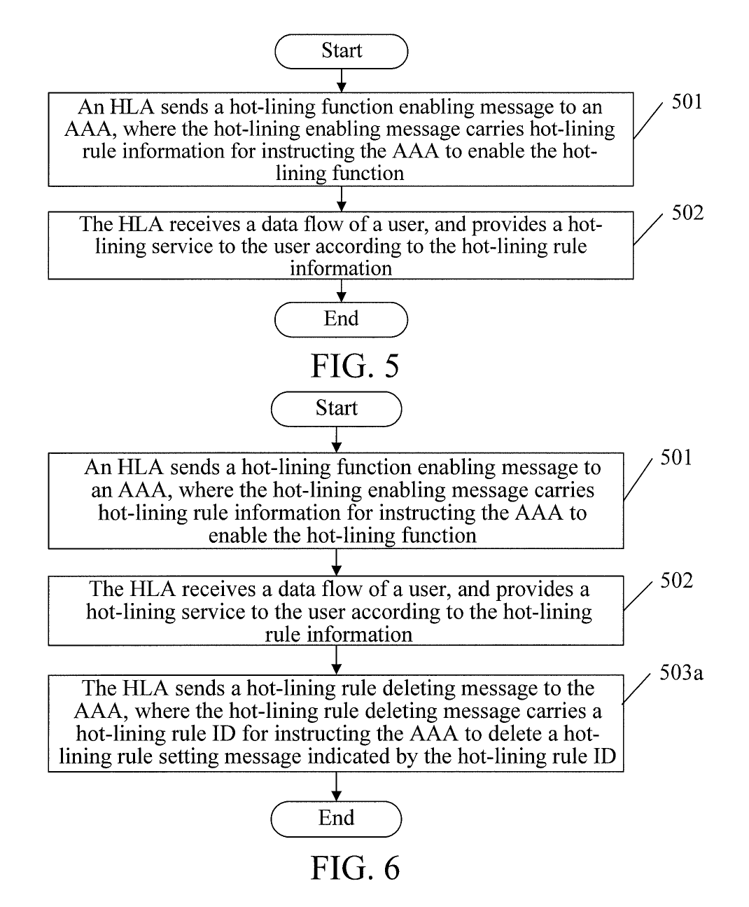

FIG. 5 is a flow chart of a method for implementing a hot-lining function according to further another embodiment of the present invention, which includes the following steps:

Step 501: An HLA sends a hot-lining function enabling message to an AAA, where the hot-lining function enabling message carries hot-lining rule information for instructing the AAA to enable the hot-lining function.

Step 502: The HLA receives a data flow of a user, and provides a hot-lining service to the user according to the hot-lining rule information.

In further another embodiment of the present invention, as shown in FIG. 6, a method for implementing a hot-lining function includes the following steps:

Step 501: An HLA sends a hot-lining function enabling message to an AAA, where the hot-lining function enabling message carries hot-lining rule information for instructing the AAA to enable the hot-lining function.

In this embodiment, the hot-lining function enabling message may be hot-lining rule setting information. The hot-lining rule information carried in the hot-lining rule setting information may include a hot-lining rule ID, a hot-lining rule scope, a hot-line rule triggering condition, a user identity, a hot-lining rule type, a hot-lining rule, and hot-lining session duration.

Step 502: The HLA receives a data flow from a user, and provides a hot-lining service to the user according to the hot-lining rule information.

In this embodiment, the hot-lining services that the HLA provides to the user may include forbidding the normal packet data service application of the user, notifying the user that the packet data application is already blocked, providing the user with a solution for terminating the hot-lining status, and instructing the user to terminate the hot-lining status.

Step 502 may provide the user with the solution for terminating the hot-lining status by using two methods. In one method, the solution for terminating the hot-lining status of the user is acquired from prestored solutions according to the hot-lining rule information. In the other method, the data flow of the user is sent by the HLA to a network device that can provide a service for terminating the hot-lining status according to the hot-lining rule information, where the network device provides the service to the user, and the HLA receives the service result returned by the network device. For example, the data flow of the user is sent by the HLA to a web page, in which the web page provides the user with the service for terminating the hot-lining status, and the HLA receives the service result returned by the web page. Of course, the two methods are taken for example only. In practical use, other methods may be adopted to provide the user with the solution for terminating the hot-lining status, and the details are not described herein again.

After the HLA provides the hot-lining service for the user and acquires the hot-lining service result, the method for implementing the hot-lining function may further include the following steps:

Step 503a: The HLA sends a hot-lining rule deleting message to the AAA, where the hot-lining rule deleting message carries a hot-lining rule ID for instructing the AAA to delete the hot-lining rule setting message indicated by the hot-lining rule ID. As for the specific implementation of step 503a, reference may be made to step 104a shown in FIG. 2, and the details are not described herein again.

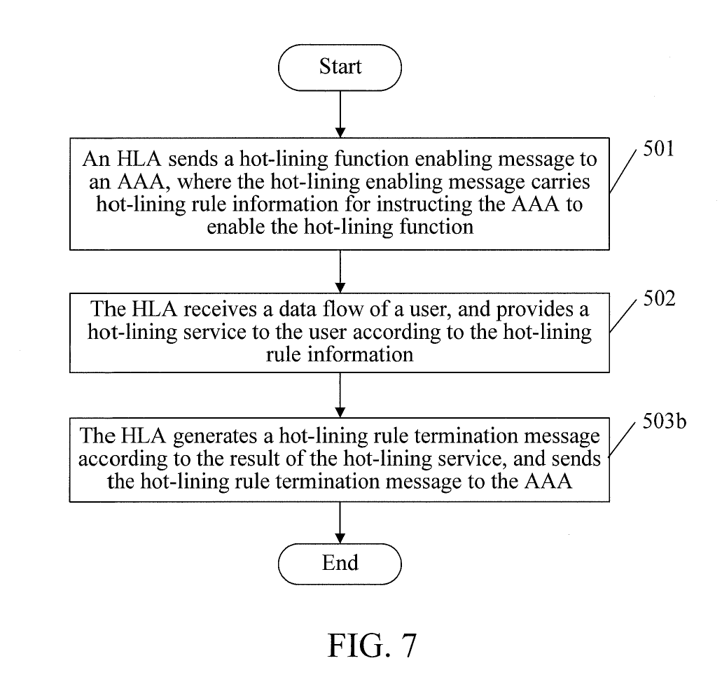

In further another embodiment of the present invention, as shown in FIG. 7, the method for implementing a hot-lining function includes the following steps:

Step 501: An HLA sends a hot-lining function enabling message to an AAA, where the hot-lining function enabling message carries hot-lining rule information for instructing the AAA to enable the hot-lining function.

In this embodiment, the hot-lining function enabling message may be a hot-lining rule triggering message. The hot-lining rule information carried in the hot-lining rule triggering message may include a user identity (including an NAI of a user or a terminal identity of the user), a hot-lining rule type, a hot-lining rule, and hot-lining session duration.

Step 502: The HLA receives a data flow of a user, and provides a hot-lining service to the user according to the hot-lining rule information. As for the specific implementation of the method, reference may be made to step 502 shown in FIG. 6, and the details are not described herein again.

After the HLA provides the hot-lining service for the user and acquires the hot-lining service result, the method for implementing the hot-lining function may further include the following steps:

Step 503b: The HLA generates a hot-lining rule termination message according to the hot-lining service result, and sends the hot-lining rule termination message to the AAA.

In this embodiment, the hot-lining rule termination message may include information such as a user identity (including an NAI of a user or a terminal identity of the user) and a hot-lining problem/condition termination result.

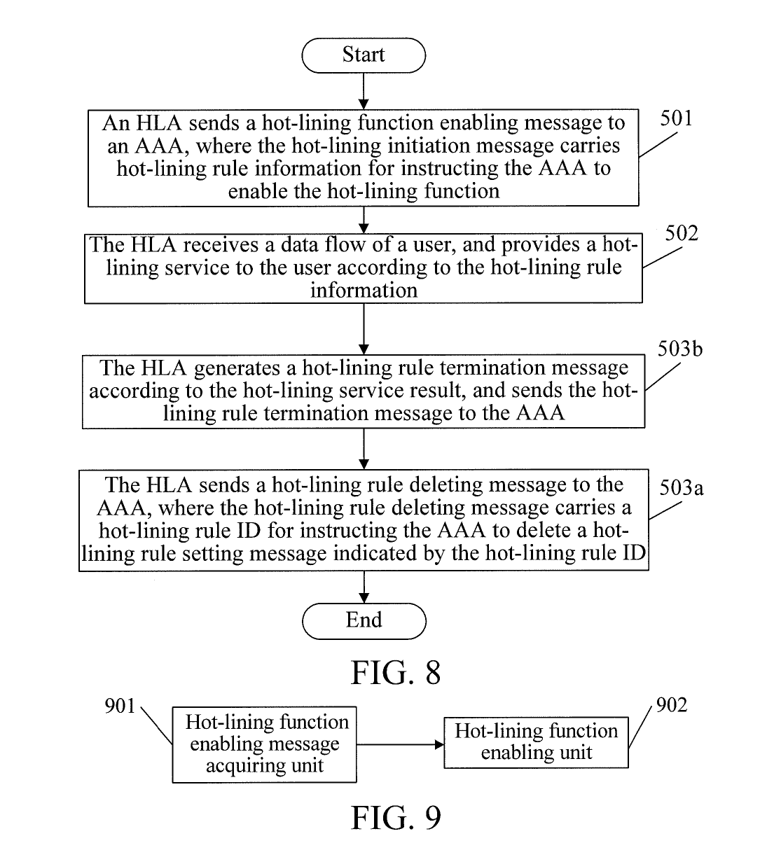

In further another embodiment of the present invention, as shown in FIG. 8, the method for implementing a hot-lining function includes the following steps:

Step 501: An HLA sends a hot-lining function enabling message to an AAA, where the hot-lining function enabling message carries hot-lining rule information for instructing the AAA to enable the hot-lining function.

In this embodiment, the hot-lining function enabling message may be hot-lining rule setting information. The hot-lining rule information carried in the hot-lining rule setting information may include a hot-lining rule ID, a hot-lining rule scope, a hot-line rule triggering condition, a user identity, a hot-lining rule type, a hot-lining rule, and hot-lining session duration, where the HLA sets hot-lining rule scope to global users.

Step 502: The HLA receives a data flow of a user, and provides a hot-lining service to the user according to the hot-lining rule information. As for the specific implementation of the method, reference may be made to step 502 shown in FIG. 6, and the details are not described herein again.

After the HLA provides the hot-lining service for the user and acquires the hot-lining service result, the method for implementing the hot-lining function may further include the following steps:

Step 503b: The HLA generates a hot-lining rule termination message according to the hot-lining service result, and sends the hot-lining rule termination message to the AAA.

In this embodiment, the hot-lining rule termination message may include a user identity (including an NAI of a user or a terminal identity of the user) and a hot-lining problem/condition termination result.

Further, in this embodiment, after step 503b, the method may further include the following steps:

Step 503a: The HLA sends a hot-lining rule deleting message to the AAA, where the hot-lining rule deleting message carries a hot-lining rule ID for instructing the AAA to delete the hot-lining rule setting message indicated by the hot-lining rule ID. As for the specific implementation of step 503a, reference may be made to step 104a shown in FIG. 2, and the details are not described herein again.

The method for implementing the hot-lining function according to the embodiment implements the hot-lining function, enables the user to enjoy continuous experience when the user has some problems to access the network or acquire the network service, and terminate the hot-lining function in time when the problems of the user are solved, so as to guarantee normal service operation of the user.

Corresponding to the method, as shown in FIG. 9, an embodiment of the present invention further provides an Authentication, Authorization and Accounting (AAA) network element, which includes a hot-lining function enabling message acquiring unit 901 and a hot-lining function enabling unit 902.

The hot-lining function enabling message acquiring unit 901 is configured to acquire a hot-lining function enabling message sent from a HLA network element, where the hot-lining function enabling message carries hot-lining rule information.

The hot-lining function enabling unit 902 is configured to enable the hot-lining function according to the hot-lining rule information, and instruct an HLD to enable the hot-lining function according to the hot-lining rule information.

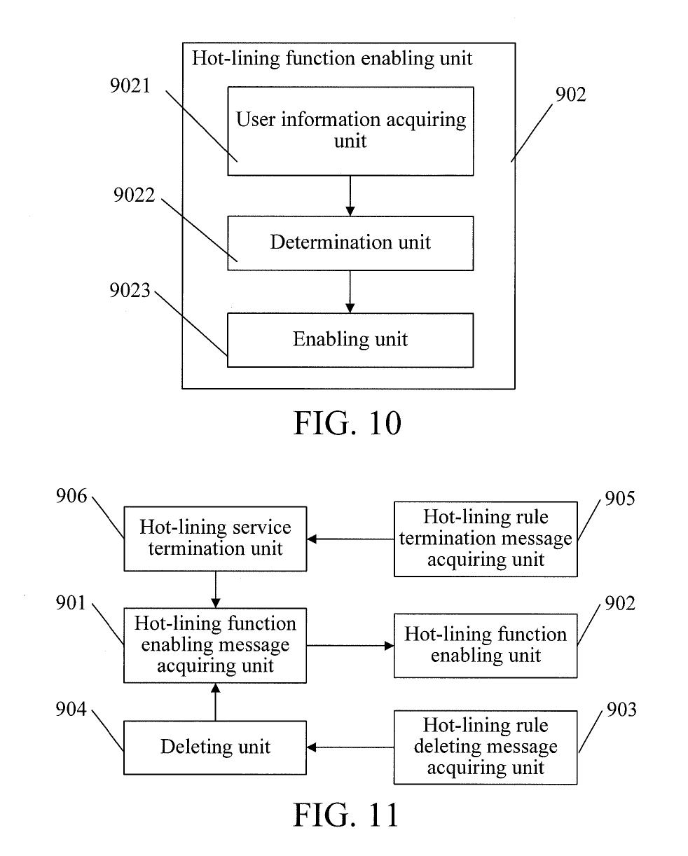

Further, as shown FIG. 10, the hot-lining function enabling unit 902 may include a user information acquiring unit 9021, a determining unit 9022, and an enabling unit 9023.

The user information acquiring unit 9021 is configured to acquire user information when the hot-lining function enabling message is a hot-lining rule setting message.

The determining unit 9022 is configured to determine whether the hot-lining rule triggering condition carried in the hot-lining rule setting message is met according to the user information.

The enabling unit 9023 is configured to enable the hot-lining function when the hot-lining rule triggering condition is met.

Further, as shown in FIG. 11, the AAA network element may include a hot-lining rule deleting message acquiring unit 903 and a deleting unit 904.

The hot-lining rule deleting message acquiring unit 903 is configured to acquire a hot-lining rule deleting message sent from the HLA network element when the hot-lining function enabling message is the hot-lining rule setting message, where the hot-lining rule deleting message carries a hot-lining rule ID.

The deleting unit 904 is configured to delete the hot-lining rule setting message indicated by the hot-lining rule ID.

Further, as shown in FIG. 11, the AAA network element may further include a hot-lining rule termination message acquiring unit 905 and a hot-lining service termination unit 906.

The hot-lining rule termination message acquiring unit 905 is configured to acquire the hot-lining rule termination message sent from the HLA network element.

The hot-lining service termination unit 906 is configured to terminate the hot-lining service according to the hot-lining rule termination message.

The AAA network element according to the present invention enables the hot-lining function according to the hot-lining rule information carried in the hot-lining function enabling message sent from the HLA network element, and instructs the HLD to enable the hot-lining function according to the hot-lining rule information, and the HLA network element provides the hot-lining service for the user. The AAA network element according to the present invention clearly specifies messages needing to be transmitted and asks needing to be accomplished during the enabling of the hot-lining function, so as to implement the hot-lining function.

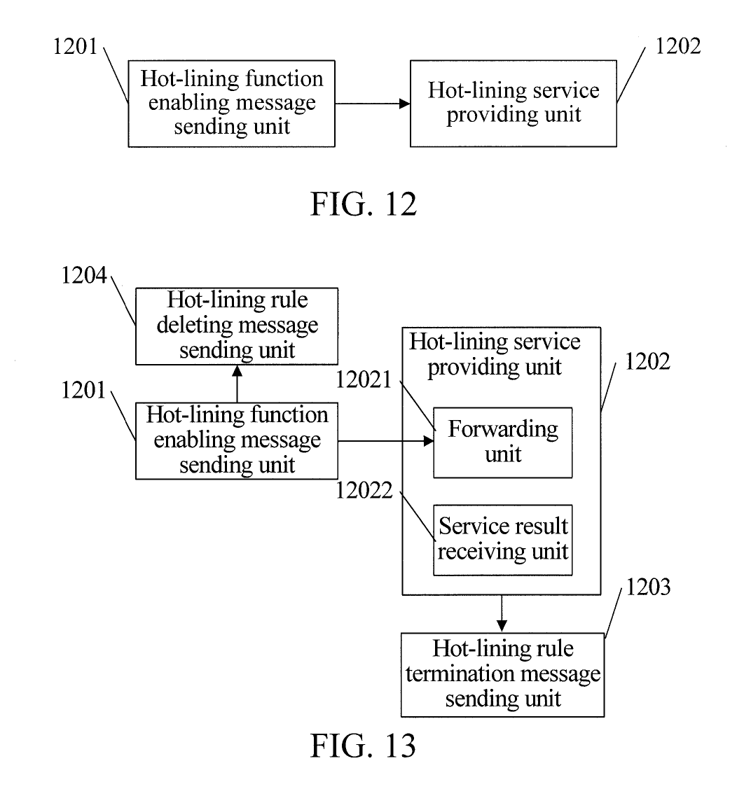

As shown in FIG. 12, an embodiment of the present invention further provides an HLA network element, which includes a hot-lining function enabling message sending unit 1201 and a hot-lining service providing unit 1202.

The hot-lining function enabling message sending unit 1201 is configured to send a hot-lining function enabling message to the AAA network element, where the hot-lining function enabling message carries hot-lining rule information, and instruct the AAA network element to enable the hot-lining function according to the hot-lining rule information.

The hot-lining service providing unit 1202 is configured to receive a data flow of a user, and provide a hot-lining service to the user according to the hot-lining rule information.

Further, as shown FIG. 13, the hot-lining service providing unit 1202 may include a forwarding unit 12021 and a service result receiving unit 12022.

The forwarding unit 12021 is configured to send the data flow of the user to a network device that can provide a service for terminating the hot-lining status.

The service result receiving unit 12022 is configured to receive a service result returned by the network device.

Further, as shown FIG. 13, the HLA network element may further include a hot-lining rule termination message sending unit 1203.

The hot-lining rule termination message sending unit 1203 is configured to generate a hot-lining rule termination message according to the hot-lining service result acquired by the hot-lining service providing unit 1202, and send the hot-lining rule termination message to the AAA network element.

Further, as shown FIG. 13, the HLA network element may include a hot-lining rule deleting message sending unit 1204.

The hot-lining rule deleting message sending unit 1204 is configured to send a hot-lining rule deleting message to the AAA network element when the hot-lining function enabling message is the hot-lining rule setting message, where the hot-lining rule deleting message carries a hot-lining rule ID for instructing the AAA to delete the hot-lining rule setting message indicated by the hot-lining rule ID.

The HLA network element according to this embodiment of the present invention clearly defines tasks needing to be accomplished and information needing to be transmitted by the HLA network element, making the HLA network element an independent network entity, and achieves the objective of implementing the hot-lining function using the HLA network element that is able to provide the hot-lining service for the user.

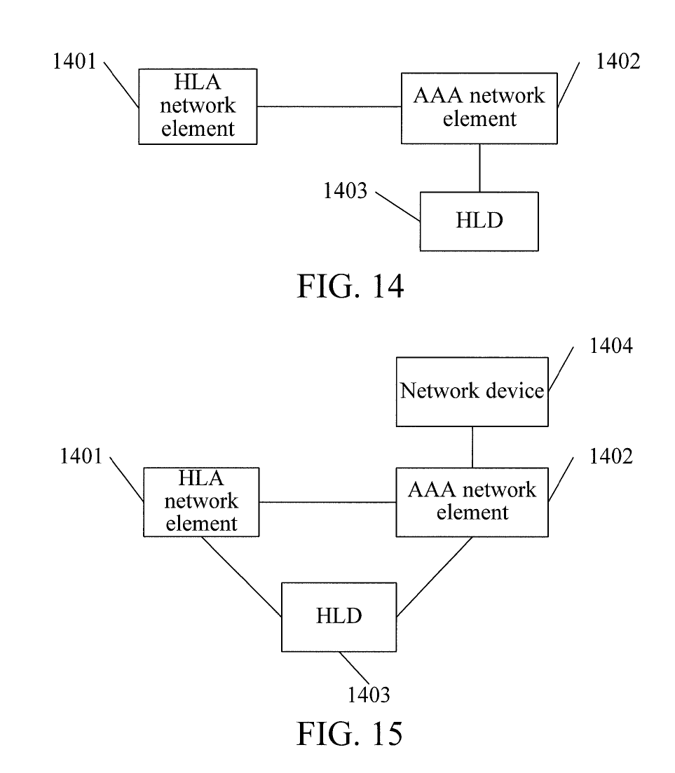

As shown in FIG. 14, an embodiment of the present invention provides a system for implementing a hot-lining function, which includes an HLA network element 1401, an AAA network element 1402, and an HLD 1403.

The HLA network element 1401 is configured to send a hot-lining function enabling message carrying hot-lining rule information to the AAA network element 1402, receive a data flow of a user from the HLD 1403, and provide a hot-lining service to the user according to the hot-lining rule information.

The AAA network element 1402 is configured to receive the hot-lining function enabling message sent from the HLA network element 1401, enable the hot-lining function according to the hot-lining rule information carried in the hot-lining function enabling message, and instruct the HLD 1403 to enable the hot-lining function according to the hot-lining rule information.

The HLD 1403 is configured to enable the hot-lining function according to an instruction of the AAA network element 1402.

Further, as shown FIG. 15, the system for implementing the hot-lining function may further include at least one network device 1404, the HLD 1403, and the HLA network element 1401.

The at least one network device 1404 (only one network device 1404 is shown in FIG. 15 as an example) is configured to provide a service for terminating the hot-lining status.

The HLD 1403 is specifically configured to redirect the data flow of the user to the HLA network element 1401 according to the instruction of the AAA network element 1402.

The HLA network element 1401 is further configured to receive the data flow of the user, send the data flow to the network device 1404, and receive the service result returned by the network device 1404.

Further, the HLA network element 1401 may be further configured to generate a hot-lining rule termination message according to the hot-lining service result, and send the hot-lining rule termination message to the AAA network element 1402.

The AAA network element 1402 may be further configured to receive the hot-lining rule termination message, and terminate the hot-lining service according to the hot-lining rule termination message.

Further, the HLA network element 1401 may be further configured to send a hot-lining rule deleting message to the AAA network element 1402 when the hot-lining function enabling message is a hot-lining rule setting message.

The AAA network element 1402 may be further configured to receive the hot-lining rule deleting message, and delete the hot-lining rule setting message indicated by the hot-lining rule ID carried in the hot-lining rule deleting message.

In the system for implementing the hot-lining function provided in an embodiment of the present invention, the HLA network element sends the hot-lining function enabling message to the AAA network element when the hot-lining function needs to be enabled, the AAA networking element enables the hot-lining function according the hot-lining rule information carried in the hot-lining function enabling message and instructs the HLD to enable the hot-lining function according to the hot-lining rule information, the HLD redirects the data flow of the user to the HLA network element after enabling the hot-lining function, and the HLA network element provides the hot-lining service for the user. The technical solution according to the present invention clearly defines messages needing to be transmitted and tasks needing to be accomplished during the enabling of the hot-lining function, achieving the objective of implementing the hot-lining function.

The method, the apparatus, and the system for implementing the hot-lining function according to the present invention are applicable in multiple services, and the applications of the method, the apparatus, and the system for implementing the hot-lining function according to the present invention are described below in detail with reference to the specific embodiments.

### Embodiment 1

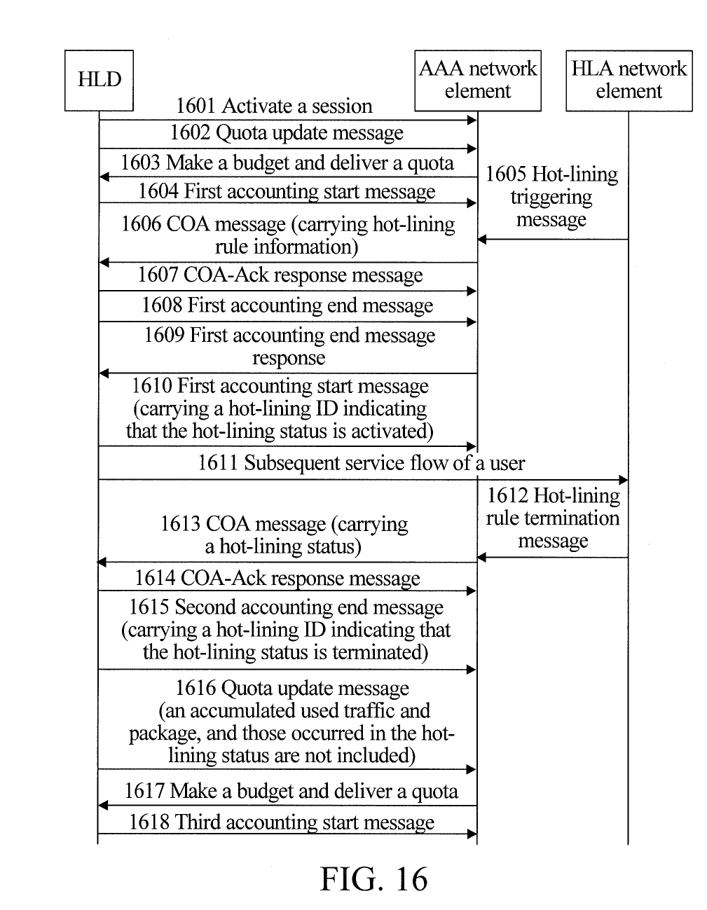

An operator sends advertisements to a user by enabling a hot-lining function when the user is online through the method, the apparatus, and the system for implementing the hot-lining function according to the present invention. As shown in FIG. 16, the process includes the following steps:

Step 1601: Negotiation is conducted between an HLD and an Home Authentication Authorization and Accounting (HAAA) to activate a session, where the HLD has the hot-lining capability.

Step 1602: The HLD reports a quota update message to the HAAA for requiring a quota.

Step 1603: The HAAA makes a budget according to the quota update message and delivers the quota to the HLD.

Step 1604: The HLD reports a first accounting start message to the HAAA; the HAAA records call detail records (CDR), and at this time, subsequent packet data sessions and transmission of the user are normally routed.

Step 1605: The operator sends a hot-lining rule triggering message to the HAAA through the HLA, where hot-lining rule information carried in the hot-lining rule triggering message includes a user identity, a hot-lining rule type, a hot-lining rule, and hot-lining session duration.

In this embodiment, the user identity is specifically the NAI of the user or the terminal identity of the user. The hot-lining rule type is the HTTP redirection description, the hot-lining rule is the address of the advertisement page, and the hot-lining session duration is 15 seconds.

Step 1606: The HAAA responds to the hot-lining rule triggering message sent by the HLA, determines the user for which the hot-lining function is to be enabled according to the user identity, determines that the type of the hot-lining function to be enabled is the HTTP-Redirection-Rule according to the HTTP redirection description, further determines that the specific hot-lining function to be enabled among the hot-lining function type is redirecting to the HTTP advertisement page according to the hot-lining rule, delivers the hot-lining rule information to the HLD through a Change-of-Authorization (COA) message, and at the same time records a “hot-lining status label” for the session of the user to indicate that the HAAA has already enabled the hot-lining function for the user.

Step 1607: After successfully processing the COA, the HLD sends a COA-Ack response message to the HAAA.

Step 1608: The HLD reports a first accounting end message to the HAAA, and the HAAA performs settlement, returns a result, and records CDR.

Step 1609: The HAAA sends a response to the first accounting end message to the HLD.

Step 1610: The HLD reports a second accounting start message to the HAAA, where the second accounting start message carries a hot-lining identity indicating that the HLD has already activated the hot-lining status for the user, and the HAAA records CDR.

In this embodiment, when the user is a mobile user, the registration procedure of the mobile user is included before the accounting starts, and the details are not described herein.

Step 1611: The HLD redirects subsequent service flows of the user to the advertisement page provided by the HLA according to the hot-lining rule type and the hot-lining rule in the hot-lining rule information.

Step 1612: When the hot-lining session duration in the hot-lining rule information reaches 15 seconds, the HLA sends a hot-lining rule termination message to the HAAA, where the hot-lining rule termination message includes the user identity and the hot-lining problem/condition termination result.

Step 1613: Upon receiving the hot-lining rule termination message, the HAAA terminates the hot-lining function for the user indicated by the user identity according to information of successful termination of the hot-lining function indicated by the hot-lining problem/condition termination result, and delivers the COA message for requiring to terminate the hot-lining status for the user to the HLD.

Step 1614: After successfully processing the COA, the HLD sends a COA-Ack message to the HAAA.

Step 1615: The HLD reports a second accounting end message to the HAAA, where the second accounting end message carries a hot-lining identity indicating that the HLD has already terminated the hot-lining status for the user, and the HAAA records the CDR.

Step 1616: The HLD reports the quota update message for requiring the quota to the HAAA (the message reports the accumulated used traffic and packages, and those occurred in the hot-lining state are not included).

Step 1617: The HAAA makes the budget and delivers the quota (when the user is a pre-paid subscriber, the HAAA does not charge for the duration during hot-lining process of the user according to the “hot-lining status label”, and when the user is a post-paid subscriber, the HAAA does not charge for the duration of the hot-lining process of the user according to the hot-lining identity), and the HAAA deletes the “hot-lining status label”.

Step 1618: The HLD reports a third accounting start message to the HAAA, where the third accounting start message does not carry a hot-lining identity, and reports that the accumulated used traffic and package are zero, the HAAA records the CDR, and at this time subsequent packet data sessions and transmission of the user are normally routed.

In this embodiment, steps 1605 to 1615 may be triggered by the HLA multiple times when the user is online.

In this embodiment, through the method, the apparatus, and the system for implementing the hot-lining function according to the present invention, the operator is able to make profit by promoting advertisements through the hot-lining function.

### Embodiment 2

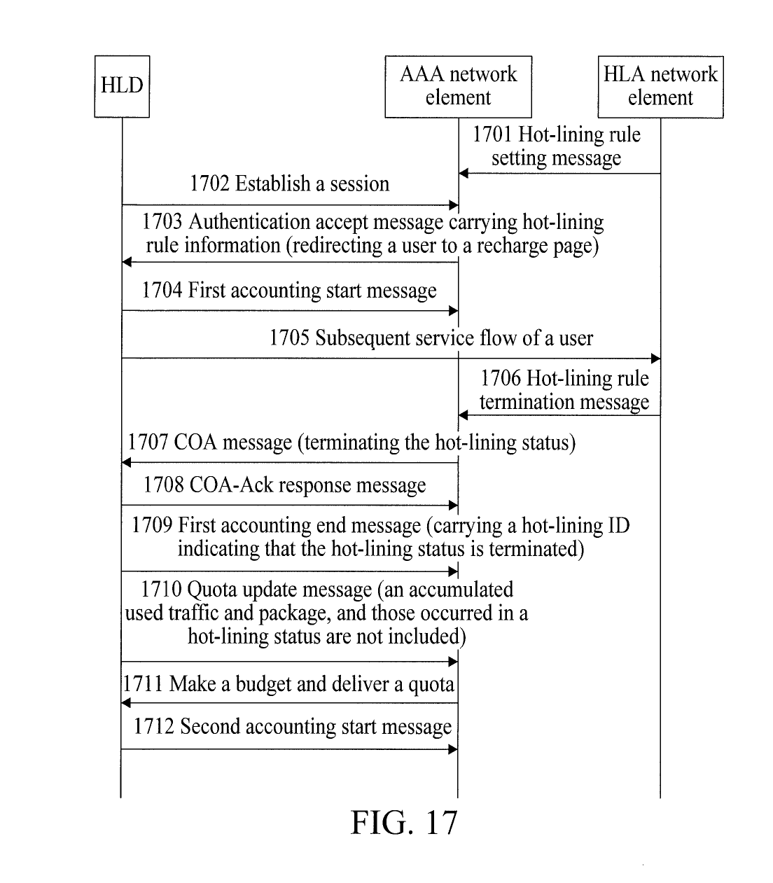

If an account balance of a pre-paid user is insufficient when the user is online, the method, the apparatus, and the system for implementing the hot-lining function according to the present invention guide the user to a recharge page, and remind the user to recharge in time. When the user recharges in time, the normal services are recovered. As shown in FIG. 17, the process includes the following steps:

Step 1701: An HLA sends a hot-lining rule setting message to an HAAA, where hot-lining rule information carried in the hot-lining rule setting message may include a hot-lining rule ID, a hot-lining rule scope, a hot-lining rule triggering condition, a user identity, a hot-lining rule type, a hot-lining rule, and hot-lining session duration.

The hot-lining rule scope covers global users, the hot-lining triggering condition is enabling when account balance is insufficient, the user identity is empty, the hot-lining rule type is HTTP redirection description, the hot-lining rule is the address of the recharge page, and the hot-lining session duration is 1200 seconds.

Step 1702: Negotiation is conducted between the HLD and the HAAA to establish a new session, where the HLD has the hot-lining capability.

Step 1703: The HAAA obtains the budget and finds that the balance of the user is in sufficient (in this embodiment, the usable traffic is zero), and the HAAA determines that the type of the hot-lining function to be enabled is HTTP-Redirection-Rule according to the HTTP redirection description, further determines that the specific hot-lining function among the hot-lining function type is redirecting to the HTTP recharge page according to the hot-lining rule, enables the hot-lining function, and delivers the hot-lining rule information to the HLD through an authentication accept message.

Step 1704: The HLD reports a first accounting start message to the HAAA, where the first accounting start message carries a hot-lining identity indicating that the HLD has already activated the hot-lining status for the user, and the HAAA records the CDR.

In this embodiment, when the user is a mobile user, the registration procedure of the mobile user is included before the accounting starts, and the details are not described herein.

Step 1705: The HLD redirects subsequent service flows of the user to the recharge page linking with the HLA according to the hot-lining rule type and the hot-lining rule in the hot-lining rule information.

Step 1706: After the user successfully recharges on the recharge page, the HLA sends a hot-lining rule termination message to the HAAA, where the hot-lining rule termination message includes the user identity and the hot-lining problem/condition termination result.

Step 1707: Upon receiving the hot-lining rule termination message, the HAAA terminates the hot-lining function for the user indicated by the user identity according to information of the successful termination of the hot-lining function indicated by the hot-lining problem/condition termination result, and delivers the COA message for requiring to terminate the hot-lining status for the user to the HLD.

Step 1708: After successfully processing the COA, the HLD sends a COA-Ack message to the HAAA.

Step 1709: The HLD reports a first accounting end message to the HAAA, where the first accounting end message carries a hot-lining identity indicating that the HLD has already terminated the hot-lining status for the user, and the HAAA keeps the CDR.

Step 1710: The HLD reports the quota update message requiring the quota to the HAAA (the message reports the accumulated used traffic and packages, and those occurred in the hot-lining status are not included).

Step 1711: The HAAA makes a budget and delivers the quota (the HAAA does not charge for duration of the hot-lining process).

Step 1712: The HLD reports a second accounting start message to the HAAA, where the second accounting start message does not carry a hot-lining identity, and the message reports that the accumulated used traffic and package are zero, the HAAA records CDR, and at this time subsequent packet data sessions and transmission of the user are normally routed.

The method, the apparatus, and the system for implementing the hot-lining function according to the present invention guide the pre-paid user to the recharge page through the hot-lining function if the balance of the user is insufficient when the user is online, and after recharge, the user can access a network immediately without dialing up again. This frees the user from recharging makes at the business hall and makes the operations become more convenient for the user, improving the experience of the user.

### Embodiment 3

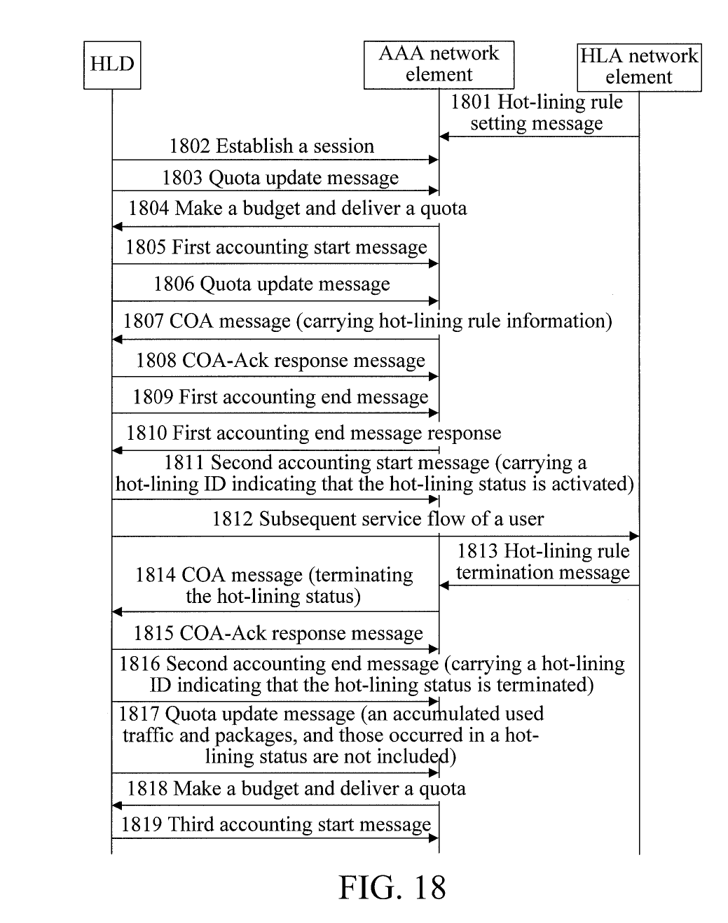

If the account balance of a pre-paid user is lower than a certain threshold when the user is online, the method, the apparatus, and the system for implementing the hot-lining function displays a window to notify the user of the account balance and suggest the user to recharge. As shown in FIG. 18, the process includes the following steps:

Step 1801: An HLA sends a hot-lining rule setting message to an HAAA, where hot-lining rule information carried in the hot-lining rule setting message may include a hot-lining rule ID, a hot-lining rule scope, a hot-lining rule triggering condition, a user identity, a hot-lining rule type, a hot-lining rule, and hot-lining session duration.

The hot-lining rule scope covers global users, the hot-lining rule triggering condition is enabling when the balance is less than zero, the user identity is empty, the hot-lining rule type is the IP Redirection Description, and the hot-lining rule is the IP address of the notification interface, and information such as the balance value and the solution advice are notified. In this embodiment, the solution advice may be information of a link to the recharge page.

Step 1802: Negotiation is conducted between the HLD and the HAAA to establish a new session, where the HLD has the hot-lining capability.

Step 1803: The HLD reports a quota update message to the HAAA for requiring a quota.

Step 1804: The HAAA makes a budget according to the quota update message and delivers the quota to the HLD.

Step 1805: The HLD reports a first accounting start message to the HAAA, and the HAAA records the CDR, and at this time, subsequent packet data sessions and transmission of the user are normally routed.

Step 1806: The HLD sends the quota update message to the HAAA.

Step 1807: The HAAA receives the quota update message and finds that the balance of the user is insufficient (for example, the available traffic is zero), determines that the user meets the hot-lining rule triggering condition, determines that the type of the hot-lining function to be enabled is IP-Redirection-Rule according to the IP Redirection Description, further determines that the specific hot-lining function to be enabled in the hot-lining function type is redirecting to the notification page according to the hot-lining rule, enables the hot-lining function, delivers the hot-lining rule information to the HLD through a COA message, and at the same time records a “hot-lining status label” for the session of the user indicating that the HAAA has already enables the hot-lining function for the user.

Step 1808: After successfully processing the COA, the HLD sends a COA-Ack response message to the HAAA.

Step 1809: The HLD reports a first accounting end message to the HAAA.

Step 1810: The HAAA responds to the first accounting end message, performs settlement, and returns and records the CDR.

Step 1811: The HLD reports a second accounting start message to the HAAA, where the second accounting start message carries a hot-lining identity indicating that the HLD has already activated the hot-lining status for the user, and the HAAA records CDR.

In this embodiment, when the user is a mobile user, the registration procedure of the mobile user is included before the accounting starts, and the details are not described here.

Step 1812: The HLD redirects subsequent service flows of the user to the notification interface provided by the HLA according to the hot-lining rule type and the hot-lining rule in the hot-lining rule information, and further, the HLA may link the subsequent service flows of the user to the recharge page indicated by the link provided on the notification interface.

Step 1813: After the user successfully recharges on the recharge interface, the HLA sends a hot-lining rule termination message to the HAAA, where the hot-lining rule termination message includes the user identity and the hot-lining problem/condition termination result.

Step 1814: Upon receiving the hot-lining rule termination message, the HAAA terminates the hot-lining function for the user indicated by the user identity according to information of successful termination of the hot-lining function indicated by the hot-lining problem/condition termination result, and delivers the COA message for requiring to terminate the hot-lining status of the user.

Step 1815: After successfully processing the COA, the HLD sends a COA-Ack message to the HAAA.

Step 1816: The HLD reports a second accounting end message to the HAAA, where the second accounting end message carries a hot-lining identity indicating that the HLD has already terminated the hot-lining status for the user, and the HAAA records the CDR.

Step 1817: The HLD reports the quota update message requiring the quota to the HAAA (the message reports the accumulated used traffic and packages, and those occurred in a hot-lining condition are not included).

Step 1818: The HAAA makes a budget and delivers the quota (the HAAA does not charge for the duration of the hot-lining process of the pre-paid subscriber according to the “hot-lining status label”), and the HAAA deletes the “hot-lining status label”.

Step 1819: The HLD reports a third accounting start message to the HAAA, where the third accounting start message does not carry a hot-lining identity, the message reports that the accumulated used traffic and packet are zero, the HAAA records the CDR, and at this time subsequent packet data sessions and transmission of the user are normally routed.

The method, the apparatus, and the system for implementing the hot-lining function according to the present invention notifies the user of the balance information in time when the user is online, reduce the possibility that the user fails to access a network for consumption because the user forgets to recharge the account, and thereby improves the experience of the user.

The method, the apparatus, and the system for implementing the hot-lining function according to the present invention are applied not only in the services of the above three embodiments, but also in other services, for example, notifying a post-paid subscriber who has not paid for a long time; pointing out the failure causes and providing corresponding solutions (such as a custom service number) when the user fails to log on to a network; and periodically sending, by the operator, costumer-associated service information to the user.

The method, the apparatus, and the system for implementing the hot-lining function according to the present invention may be applied in a fixed network and a wireless network, such as the WiMAX network or CDMA network system in the wireless networks, so as to implement the hot-lining function.

Persons of ordinary skill in the art should understand that all or a part of the steps of the method according to the embodiments of the present invention may be implemented by a program instructing relevant hardware. The program may be stored in a computer readable storage medium, such as a read-only memory (ROM), a random access memory (RAM), a magnetic disk, and an optical disk.

The above descriptions are merely specific embodiments of the present invention, but not intended to limit the scope of the present invention. Any modification or replacement made by persons skilled in the art without departing from technical solutions disclosed in the present invention should fall within the protection scope of the present invention. Therefore, the scope of the present invention is subject to the scope of the claims.

What is claimed is:

1. A method for implementing a hot-lining function, comprising:
acquiring a hot-lining function enabling message sent from a hot-lining application (HLA) network element, wherein the hot-lining function enabling message carries hot-lining rule information; and
enabling a hot-lining function according to the hot-lining rule information, and instructing a hot-lining device (HLD) to enable the hot-lining function according to the hot-lining rule information.

2. The method for implementing a hot-lining function according to claim 1, wherein when the hot-lining function enabling message is a hot-lining rule setting message, hot-lining rule information carried in the hot-lining rule setting message comprises more than one of following types of information: a hot-lining rule identifier (ID), a hot-lining rule scope, a hot-lining rule triggering condition, a user identity, a hot-lining rule type, a hot-lining rule or a hot-lining session duration; or
when the hot-lining function enabling message is a hot-lining rule triggering message, the hot-lining rule information carried in the hot-lining rule triggering message comprises more than one of following types of information: a user identity, a hot-lining rule type, a hot-lining rule, and a hot-lining session duration.

3. The method for implementing a hot-lining function according to claim 2, further comprising:
acquiring a hot-lining rule deleting message sent from the HLA network element, wherein the hot-lining rule deleting message carries a hot-lining rule ID; and
deleting a hot-lining rule setting message indicated by the hot-lining rule ID.

4. The method for implementing a hot-lining function according to claim 1, further comprising:
acquiring a hot-lining rule termination message sent from the HLA network element; and
terminating a hot-lining service according to the hot-lining rule termination message.

5. The method for implementing a hot-lining function according to claim 2, further comprising:
acquiring a hot-lining rule termination message sent from the HLA network element; and
terminating a hot-lining service according to the hot-lining rule termination message.

6. A method for implementing a hot-lining function, comprising:
sending a hot-lining function enabling message to an authentication, authorization and accounting (AAA) network element, wherein the hot-lining function enabling message carries hot-lining rule information and instructs the AAA network element to enable the hot-lining function according to the hot-lining rule information; and
receiving a data flow of a user, and providing a hot-lining service to the user according to the hot-lining rule information.

7. The method for implementing a hot-lining function according to claim 6, wherein the providing the hot-lining service to the user according to the hot-lining rule information comprises:
sending the data flow of the user to a network device capable of providing a service for terminating a hot-lining status according to the hot-lining rule information; and
receiving a service result returned by the network device.

8. The method for implementing a hot-lining function according to claim 6, further comprising:
generating a hot-lining rule termination message according to a hot-lining service result, and sending the hot-lining rule termination message to the AAA network element.

9. The method for implementing a hot-lining function according to claim 6, when the hot-lining function enabling message is a hot-lining rule setting message, and the method further comprising:
sending a hot-lining rule deleting message to the AAA network element, wherein the hot-lining rule deleting message carries a hot-lining rule identifier (ID) and instructs the AAA network element to delete the hot-lining rule setting message indicated by the hot-lining rule ID.

10. An authentication, authorization and accounting (AAA) network element, comprising:
a hot-lining function enabling message acquiring unit (901), configured to acquire a hot-lining function enabling message sent from a hot-lining application (HLA) network element, wherein the hot-lining function enabling message carries hot-lining rule information;
a hot-lining function enabling unit (902), configured to enable a hot-lining function according to the hot-lining rule information, and instruct a hot-lining device (HLD) to enable the hot-lining function according to the hot-lining rule information.

11. The AAA network element according to claim 10, further comprising:
a hot-lining rule deleting message acquiring unit (903), configured to acquire a hot-lining rule deleting message sent from an HLA network element when the hot-lining function enabling message is a hot-lining rule setting message, wherein the hot-lining rule deleting message carries a hot-lining rule identifier (ID);
a deleting unit 904, configured to delete the hot-lining rule setting message indicated by the hot-lining rule ID.

12. The AAA network element according to claim 10, further comprising:
a hot-lining rule termination message acquiring unit (905), configured to acquire a hot-lining rule termination message sent from the HLA network element; and
a hot-lining service termination unit (906), configured to terminate a hot-lining service according to the hot-lining rule termination message.

13. A hot-lining application (HLA) network element, comprising:
a hot-lining function enabling message sending unit 1201, configured to send a hot-lining function enabling message to an authentication, authorization and accounting (AAA) network element, wherein the hot-lining function enabling message carries hot-lining rule information, and instructs the AAA network element to enable a hot-lining function according to the hot-lining rule information; and
a hot-lining service providing unit (1202), configured to receive a data flow of a user, and provide a hot-lining service for the user according to the hot-lining rule information.

14. The HLA network element according to claim 11, wherein the hot-lining service providing unit (1202) comprises:
a forwarding unit (12021), configured to send the data flow of the user to a network device capable of providing a service for terminating a hot-lining status according to the hot-lining rule information; and
a service result receiving unit (12022), configured to receive a service result returned by the network device.

15. The HLA network element according to claim 13, further comprising:
a hot-lining rule termination message sending unit (1203), configured to generate a hot-lining rule termination message according to a hot-lining service result acquired from the hot-lining service providing unit (1202), and send the hot-lining rule termination message to the AAA network element.

16. The HLA network element according to claim 13, further comprising:
a hot-lining rule deleting message sending unit (1204), configured to send a hot-lining rule deleting message to the AAA network element when the hot-lining function enabling message is a hot-lining rule setting message, wherein the hot-lining rule deleting message carries a hot-lining rule identifier (ID) for instructing the AAA network element to delete a hot-lining rule setting message indicated by the hot-lining rule ID.

17. A system for implementing a hot-lining function, comprising:
a hot-lining application (HLA) network element (1401), configured to send a hot-lining function enabling message carrying hot-lining rule information to an authentication, authorization and accounting (AAA) network element (1402), receive a data flow of a user from a hot-lining device (HLD) (1403), and provide a hot-lining service for the user according to the hot-lining rule information;
the AAA network element (1402), configured to receive the hot-lining function enabling message sent from the HLA network element (1401), enable a hot-lining function according to the hot-lining rule information carried in the hot-lining function enabling message, and instruct the HLD (1403) to enable the hot-lining function according to the hot-lining rule information; and
the HLD (1403), configured to enable the hot-lining function according to the instruction of the AAA network element (1402).

18. The system for implementing a hot-lining function according to claim 17, further comprising:
at least one network device (1404), configured to provide a service for terminating the hot-lining status;
the HLD (1403), specifically configured to redirect the data flow of the user to the HLA network element (1401) according to the instruction of the AAA network element (1402); and
the HLA network element (1401), further configured to receive the data flow of the user, send the data flow to the network device (1404), and receive a service result returned by the network device (1404).

19. The system for implementing a hot-lining function according to claim 17, comprising:
the HLA network element (1401), further configured to generate a hot-lining rule termination message according to a hot-lining service result, and send the hot-lining rule termination message to the AAA network element (1402); and
the AAA network element (1402), further configured to receive the hot-lining rule termination message and terminate the hot-lining service according to the hot-lining rule termination message.

20. The system for implementing a hot-lining function according to claim 17, comprising:
the HLA network element (1401), further configured to send a hot-lining rule deleting message to the AAA network element (1402) when the hot-lining function enabling message is a hot-lining rule setting message; and
the AAA network element (1402), further configured to receive the hot-lining rule deleting message, and delete a hot-lining rule setting message indicated by the hot-lining rule identifier (ID) carried in the hot-lining rule deleting message.
